(19) United States
(12) Patent Application Publication
(10) Pub. No.: US 2010/0160540 A1
(43) Pub. Date: Jun. 24, 2010

(54) Process for the Nucleation of Polypropylene Resins

(75) Inventors: Claudio Cavalieri, Ferrara (IT); Fiorella Pradella, Carbonara di Po (IT)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: Basell Poliolefine Italia s.r.l., Milan (IT)

(21) Appl. No.: 11/990,108

(22) PCT Filed: Jul. 21, 2006
(86) PCT No.: PCT/EP2006/064498

§ 371 Date: Feb. 6, 2008

Related U.S. Application Data
(60) Provisional application No. 60/707,516, filed on Aug. 11, 2005.

(30) Foreign Application Priority Data
Aug. 8, 2005 (EP) 05107275.9

(51) Int. Cl. C08L 23/12

(52) U.S. Cl. 524/582; 525/240

(57) ABSTRACT

Use of propylene polymers having Polydispersity Index value P.I.(2) greater than or equal to 15 for the nucleation of polypropylene resins having a Polydispersity Index value P.I.(1) fulfilling the equation P.I.(2)−P.I.(1)≧10.

This application is the U.S. national phase of International Application PCT/EP2006/064498, filed Jul. 21, 2006, claiming priority to European Patent Application 05107275.9 filed Aug. 8, 2005, and the benefit under 35 U.S.C. 119(e) of U.S. Provisional Application No. 60/707,516, filed Aug. 11, 2005; the disclosures of International Application PCT/EP2006/064498, European Patent Application 05107275.9 and U.S. Provisional Application No. 60/707,516, each as filed, are incorporated herein by reference.

The present invention relates to a method for improving the physical, mechanical and/or optical properties of propylene polymers or propylene polymer compositions. It is known in the art that nucleating agents can be conveniently used to increase the mechanical and optical properties of polymeric materials. Several chemicals are known as nucleating agents, i.e. substances capable of raising the crystallization temperature of a molten polymer, bringing about a more rapid development of crystalline sites and inducing the formation of more numerous and smaller crystalline nuclei.

U.S. Pat. No. 3,367,926 describes the use several nucleating agents for alpha-olefins, such as for example metallic salts of aromatic or aliphatic carboxylic acids.

More recently, polymeric materials have been used for nucleating propylene polymers. The European patent EP 1 028 984 describes a process for producing propylene polymers nucleated with a polymeric nucleating agent, wherein the polymeric nucleating agent is a vinyl compound with a saturated or unsaturated substituent, in particular vinylcyclohexane. In EP 586 109 the use of 3-position branched alpha-olefins and/or vinylcycloalkane polymers as nucleating agent for polypropylene resins is disclosed. The U.S. Pat. No. 5,340,878 discloses a propylene polymer composition nucleated with crystalline ethylene polymers.

There is however still the need of effective nucleating agents for polypropylene resins that are capable of improving the physical, mechanical and/or optical properties of the polypropylene resin and of a process for nucleating a polypropylene resin making use of said nucleating agents.

The present invention concerns the use of propylene polymers having Polydispersity Index value (P.I.(2)) greater than or equal to 15 for the nucleation of polypropylene resins having a Polydispersity Index value P.I.(1) fulfilling the equation P.I.(2)−P.I.(1) ≧10.

A process for nucleating polypropylene resins is hereby disclosed, comprising the step (a) of mixing in the molten state a polyolefin composition comprising (percentages based on the sum of components (1) and (2)):
(1) from 95 to 99.9 wt % of a polypropylene resin having a Polydispersity Index value P.I.(1) and
(2) from 0.1 to 5 wt % of at least one propylene polymer having Polydispersity Index value (P.I.(2)) greater than or equal to 15,
wherein the P.I.(1) and P.I.(2) values fulfill the equation P.I.(2)−P.I.(1)≧10, preferably P.I.(2)−P.I.(1)≧15, more preferably P.I.(2)−P.I.(1)≧25, and

(b) cooling the molten blend.

According to a preferred embodiment, the step (a) of the process of the invention comprises mixing in the molten state a polyolefin composition comprising (percentages based on the sum of components (1) and (2)):

(1) from 95 to 99.9 wt % of a polypropylene resin having a Polydispersity Index value P.I.(1), crystallization temperature Tc(1) and comonomer content C(1) and

(2) from 0.1 to 5 wt % of at least one propylene polymer having Polydispersity Index value (P.I.(2)) greater than or equal to 15 and fulfilling the equation P.I.(2)−P.I.(1)≧10, said propylene polymer having crystallization temperature Tc(2) and comonomer content C(2) fulfilling at least one of the following conditions:

(i) Tc(2)≧Tc(1);

(ii) C(2)≠C(1).

More preferably both conditions (i) and (ii) are fulfilled.

Polypropylene resins (1) that can be conveniently used in the process of the invention are preferably selected among propylene homopolymers, propylene copolymers and propylene heterophasic polymers. In particular, polypropylene resins can be selected among:

(i) propylene homopolymers having solubility in xylene lower than 10 wt %, preferably lower than 5 wt %;

(ii) propylene copolymers containing from 0.05 to 20 wt %, with respect to the weight of the copolymer, of alpha-olefin units having from 2 to 10 carbon atoms other than propylene, preferred alpha-olefins being linear C₂-C₁₀-1-alkenes, in particular ethylene, 1-butene, 1-pentene, 1-hexene, 1-heptene, 1-octene, 4-methyl-1-pentene, ethylene being particularly preferred, said propylene copolymers having solubility in xylene lower than 15 wt %, preferably lower than 10 wt %;

(iii) mixtures of propylene homopolymers of item (i) and propylene copolymers of item (ii);

(iv) heterophasic compositions comprising (1) a propylene a propylene polymer selected among propylene polymers (i), (ii) and (iii), and (2) up to about 40 wt %, with respect to the weight of the heterophasic composition, of an elastomeric copolymer of propylene with up to 50 wt %, with respect to the elastomeric fraction, of one or more comonomer units selected from alpha-olefins having from 2 to 10 carbon atoms other than propylene, preferred alpha-olefins being ethylene, 1-butene, 1-pentene, 1-hexene, 1-heptene, 1-octene, 4-methyl-1-pentene, ethylene being particularly preferred, said heterophasic compositions optionally containing minor quantities (in particular, from 1% to 10 wt %) of a diene, such as butadiene, 1,4-hexadiene, 1,5-hexadiene, ethylidene-1-norbornene. By elastomeric copolymer is meant therein a copolymer having solubility in xylene, measured according to the method described below, greater than 50 wt %.

The Melt Flow Rate of the polypropylene resin (1) ranges from 0.01 to 100 g/10 min and can be properly selected in accordance with the intended use of the nucleated resin. For example, for extrusion or extrusion blow-molding the MFR of the polypropylene resin (1) can be conveniently comprised in the range 1-10 g/10 min.

Polypropylene resins (1) are commercially available on the market and can be prepared for example by polymerizing propylene and eventually the comonomers in the presence of Ziegler-Natta catalysts comprising a solid catalyst component comprising at least one titanium compound having at least one titanium-halogen bond and at least an electron-donor compound (internal donor), both supported on magnesium chloride. The Ziegler-Natta catalysts systems further comprise an organo-aluminum compound as essential co-catalyst and optionally an external electron-donor compound. Suitable catalyst systems are described in the European patents EP45977, EP361494, EP728769, EP 1272533 and in the international patent application WO00/6321. The polymerization process can be carried out in gas phase and/or in liquid phase, in continuous or batch reactors, such as fluidized bed or slurry reactors in single or multi-step processes; the gas-phase polymerization process may conveniently be carried out in at least two interconnected polymerization zones, as described in EP782587 and WO00/02929. Polypropylene compositions (iii) and heterophasic compositions (iv) may also be prepared by melt-blending the different components obtained separately according to known methods. The polypropylene resin (1) may comprise additives commonly employed in the polyolefin field, such as antioxidants, light stabilizers, antiacids, colorants, fillers and processing improvers in an amount up to 2 wt %.

The propylene polymers (2) that can be conveniently used in the process of the invention should have a broad molecular weight distribution. The molecular weight distribution can be either expressed as the ratio of the weight average molecular weight Mw to the number average molecular weight Mn or as the Polydispersity Index (P.I.). Propylene polymers (2) should have Polydispersity Index value (P.I.(2)) greater than or equal to 15, preferably the P.I.(2) value ranges from 15 to 50, more preferably from 20 to 45, particularly preferably from 20 to 35. The Polydispersity Index (P.I.) is rheologically measured under the conditions indicated below.

Propylene polymers (2) are preferably selected among propylene homopolymers, propylene copolymers containing up to 10.0 wt % (with respect to the weight of the copolymer) of alpha-olefin units having from 2 to 8 carbon atoms other than propylene and mixtures thereof. Preferred alpha-olefins are linear C₂-C₈-1-alkenes, in particular ethylene, 1-butene, 1-pentene, 1-hexene, 1-heptene, 1-octene, 4-methyl-1-pentene, ethylene being particularly preferred. Propylene copolymers (2) preferably comprise 0.5 to 6.0 wt % of alpha-olefin units. Said propylene copolymers may optionally comprise a conjugated or un-conjugated diene, such as butadiene, 1,4-hexadiene, 1,5-hexadiene and ethylidene-norbornene-1. When present, the diene is typically in an amount from 0.5 to 10 wt %. Preferred propylene homo- or copolymers (2) may also have one or more properties of the following set:
Melt Strength, measured at 230° C., higher than 1.50 cN, preferably the Melt Strength value ranges from 2.00 to 12.00 cN, more preferably from 2.00 to 8.00 cN, particularly preferably from 2.50 to 5.00 cN; and/or
MFR (ISO1133, 230° C./2.16 Kg) ranging from 0.01 to 20 g/10 min, preferably from 0.01 to 4.00 g/10 min, particularly preferably from 0.5 to less than 2.0 g/10 min; and/or
Xylene soluble fraction, measured according to the method described below, of less than 6 wt %, preferably of less than 4 wt %; and/or
Flexural Modulus (ISO178) from 700 to 2500 MPa, preferably from 1100 to 1800 MPa; and/or
Izod Impact value at 23° C. (ISO 180/1A) of less than 50.0 kJ/m², preferably 15.0 kJ/m², more preferably less than 10.0 kJ/m², particularly preferably from 3.0 to 5.0 kJ/m²; and/or
Stress at Yield (ISO 527) greater than 21 MPa, preferably in the range from 25 to 45 MPa, more preferably from 30 to 40 MPa; and/or
number of gels No(≧0.2 mm) of less than 400, preferably the number of gels No(≧0.1 mm) is less than 400.

The propylene polymers (2) may further comprise additives commonly employed in the polyolefin field, such as antioxidants, light stabilizers, antiacids, fillers and processing improvers in conventional amounts, i.e. up to 2 wt %.

Propylene polymers (2) can be prepared in presence of highly stereospecific heterogeneous Ziegler-Natta catalyst systems capable of catalyzing the production of high molecular weight propylene polymers as well as medium and low molecular weight propylene polymers.

Ziegler-Natta catalysts suitable for producing the propylene polymers (2) comprise a solid catalyst component comprising at least one titanium compound having at least one titanium-halogen bond and at least an electron-donor compound (internal donor), both supported on magnesium chloride. The Ziegler-Natta catalysts systems further comprise an organo-aluminum compound as essential co-catalyst and optionally an external electron-donor compound.

Suitable catalysts systems are described in the European patents EP45977, EP361494, EP728769, EP 1272533 and in the international patent application WO00/63261.

Preferably, the solid catalyst component comprises Mg, Ti, halogen and an electron donor selected from succinates of formula (I):

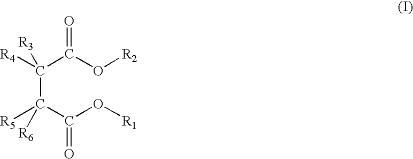

wherein the radicals R₁ and R₂, equal to or different from each other, are a C₁-C₂₀ linear or branched alkyl, alkenyl, cycloalkyl, aryl, arylalkyl or alkylaryl group, optionally containing heteroatoms; the radicals R₃ to R₆ equal to or different from each other, are hydrogen or a C₁-C₂₀ linear or branched alkyl, alkenyl, cycloalkyl, aryl, arylalkyl or alkylaryl group, optionally containing heteroatoms, and the radicals R₃ to R₆ which are joined to the same carbon atom can be linked together to form a cycle.

R₁ and R₂ are preferably C₁-C₈ alkyl, cycloalkyl, aryl, arylalkyl and alkylaryl groups. Particularly preferred are the compounds in which R₁ and R₂ are selected from primary alkyls and in particular branched primary alkyls. Examples of suitable R₁ and R₂ groups are methyl, ethyl, n-propyl, n-butyl, isobutyl, neopentyl, 2-ethylhexyl. Particularly preferred are ethyl, isobutyl, and neopentyl.

One of the preferred groups of compounds described by the formula (I) is that in which R₃ to R₅ are hydrogen and R₆ is a branched alkyl, cycloalkyl, aryl, arylalkyl and alkylaryl radical having from 3 to 10 carbon atoms. Another preferred group of compounds within those of formula (I) is that in which at least two radicals from R₃ to R₆ are different from hydrogen and are selected from C₁-C₂₀ linear or branched alkyl, alkenyl, cycloalkyl, aryl, arylalkyl or alkylaryl group, optionally containing heteroatoms. Particularly preferred are the compounds in which the two radicals different from hydrogen are linked to the same carbon atom. Furthermore, also the compounds in which at least two radicals different from hydrogen are linked to different carbon atoms, that is R₃ and R₅ or R₄ and R₆ are particularly preferred.

According to a preferred method, the solid catalyst component can be prepared by reacting a titanium compound of formula Ti(OR)_{n-y}X_{y}, where n is the valence of titanium and y is a number between 1 and n, preferably TiCl₄, with a magnesium chloride deriving from an adduct of formula MgCl₂.pROH, where p is a number between 0.1 and 6, preferably from 2 to 3.5, and R is a hydrocarbon radical having 1-18 carbon atoms. The adduct can be suitably prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Examples of spherical adducts prepared according to this procedure are described in U.S. Pat. No. 4,399,054 and U.S. Pat. No. 4,469,648. The so obtained adduct can be directly reacted with the Ti compound or it can be previously subjected to thermal controlled dealcoholation (80-130° C.) so as to obtain an adduct in which the number of moles of alcohol is generally lower than 3, preferably between 0.1 and 2.5. The reaction with the Ti compound can be carried out by suspending the adduct (dealcoholated or as such) in cold TiCl₄ (generally 0° C.); the mixture is heated up to 80-130° C. and kept at this temperature for 0.5-2 hours. The treatment with TiCl₄ can be carried out one or more times. The internal donor can be added during the treatment with TiCl₄ and the treatment with the electron donor compound can be repeated one or more times. Generally, the succinate of formula (I) is used in molar ratio with respect to the MgCl₂ of from 0.01 to 1 preferably from 0.05 to 0.5. The preparation of catalyst components in spherical form is described for example in European patent application EP-A-395083 and in the International patent application WO98/44009. The solid catalyst components obtained according to the above method show a surface area (by B.E.T. method) generally between 20 and 500 m²/g and preferably between 50 and 400 m²/g, and a total porosity (by B.E.T. method) higher than 0.2 cm³/g preferably between 0.2 and 0.6 cm³/g. The porosity (Hg method) due to pores with radius up to 10.000 Å generally ranges from 0.3 to 1.5 cm³/g, preferably from 0.45 to 1 cm³/g.

The organo-aluminum compound is preferably an alkyl-Al selected from the trialkyl aluminum compounds such as for example triethylaluminum, triisobutylaluminum, tri-n-butylaluminum, tri-n-hexylaluminum, tri-n-octylaluminum. It is also possible to use mixtures of trialkylaluminum's with alkylaluminum halides, alkylaluminum hydrides or alkylaluminum sesquichlorides such as AlEt₂Cl and Al₂Et₃Cl₃.

Preferred external electron-donor compounds include silicon compounds, esters such as ethyl 4-ethoxybenzoate, heterocyclic compounds and particularly 2,2,6,6-tetramethyl piperidine and ketones. Another class of preferred external donor compounds is that of silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms. Particularly preferred are methylcyclohexyldimethoxysilane, diphenyldimethoxysilane, methyl+butyldimethoxysilane, dicyclopentyldimethoxysilane, 2-ethylpiperidinyl-2-t-butyldimethoxysilane and 1,1,1,trifluoropropyl-2-ethylpiperidinyl-dimethoxysilane and 1,1,1,trifluoropropyl-metil-dimethoxysilane. The external electron donor compound is used in such an amount to give a molar ratio between the organo-aluminum compound and said electron donor compound of from 0.1 to 500.

Propylene polymers (2) can be preferably produced by a gas-phase polymerization process carried out in at least two interconnected polymerization zones. Said polymerization process is described in the European patent EP 782587 and in the International patent application WO00/02929. The process is carried out in a first and in a second interconnected polymerization zone to which propylene and ethylene or propylene and alpha-olefins are fed in the presence of a catalyst system and from which the polymer produced is discharged. The growing polymer particles flow through the first of said polymerization zones (riser) under fast fluidization conditions, leave said first polymerization zone and enter the second of said polymerization zones (downcomer) through which they flow in a densified form under the action of gravity, leave said second polymerization zone and are reintroduced into said first polymerization zone, thus establishing a circulation of polymer between the two polymerization zones. Generally, the conditions of fast fluidization in the first polymerization zone is established by feeding the monomers gas mixture below the point of reintroduction of the growing polymer into said first polymerization zone. The velocity of the transport gas into the first polymerization zone is higher than the transport velocity under the operating conditions and is normally between 2 and 15 m/s. In the second polymerization zone, where the polymer flows in densified form under the action of gravity, high values of density of the solid are reached which approach the bulk density of the polymer; a positive gain in pressure can thus be obtained along the direction of flow, so that it becomes possible to reintroduce the polymer into the first reaction zone without the help of mechanical means. In this way, a “loop” circulation is set up, which is defined by the balance of pressures between the two polymerization zones and by the head loss introduced into the system. Optionally, one or more inert gases, such as nitrogen or an aliphatic hydrocarbon, are maintained in the polymerization zones, in such quantities that the sum of the partial pressures of the inert gases is preferably between 5 and 80% of the total pressure of the gases. The operating parameters such as, for example, the temperature are those that are usual in gas-phase olefin polymerization processes, for example between 50° C. and 120° C., preferably from 70° C. to 90° C. The process can be carried out under operating pressure of between 0.5 and 10 MPa, preferably between 1.5 and 6 MPa. Preferably, the various catalyst components are fed to the first polymerization zone, at any point of said first polymerization zone. However, they can also be fed at any point of the second polymerization zone. In the polymerization process means are provided which are capable of totally or partially preventing the gas and/or liquid mixture present in the raiser from entering the downcomer and a gas and/or liquid mixture having a composition different from the gas mixture present in the raiser is introduced into the downcomer. According to a preferred embodiment, the introduction into the downcomer, through one or more introduction lines, of said gas and/or liquid mixture having a composition different from the gas mixture present in the raiser is effective in preventing the latter mixture from entering the downcomer. The gas and/or liquid mixture of different composition to be fed to the downcomer can optionally be fed in partially or totally liquefied form. The molecular weight distribution of the growing polymers can be conveniently tailored by carrying out the polymerization process in a reactor diagrammatically represented in FIG. 4 of the International Patent Application WO00/02929 and by independently metering the comonomer(s) and customary molecular weight regulators, particularly hydrogen, in different proportion into at least one polymerization zone, preferably into the raiser.

A further object of the present invention is a polyolefin composition comprising (percentages based on the sum of components (1) and (2)):

(1) 95-99.9 wt % of a polypropylene resin having Polydispersity Index value P.I.(1), said resin being selected among:

(i) propylene homopolymers having solubility in xylene lower than 10 wt %; (ii) propylene copolymers containing from 0.05 to 20 wt %, with respect to the weight of the copolymer, of alpha-olefin units having from 2 to 10 carbon atoms other than propylene, said propylene copolymers having solubility in xylene lower than 15 wt %; (iii) mixtures of propylene homopolymers of item (i) and propylene copolymers of item (ii); (iv) heterophasic compositions comprising (1) a propylene polymer selected among propylene polymers of item (i), (ii) and (iii), and (2) up to about 40 wt %, with respect to the weight of the heterophasic composition, of an elastomeric propylene copolymer containing up to about 50 wt %, with respect to the elastomeric fraction, of one or more comonomer units selected from alpha-olefins having from 2 to 10 carbon atoms other than propylene; and

(2) 0.1-5 wt % of a propylene polymer having Polydispersity Index value P.I.(2) greater than or equal to 15, said propylene polymer being selected among propylene homopolymers, propylene copolymers containing up to 5.0 wt % (with respect to the weight of the copolymer) of alpha-olefin units having from 2 to 8 carbon atoms other than propylene and mixtures thereof,

wherein the P.I.(1) and P.I.(2) values fulfill the equation P.I.(2)−P.I.(1)≧10.

The step (a) of the process of the invention is carried out by mixing in the molten state a polyolefin composition comprising (percentages based on the sum of components (1) and (2)):

(1) 95-99.9 wt %, preferably 97-99.5 wt %, more preferably 98-99 wt %, of a polypropylene resin having a Polydispersity Index value P.I.(1) and

(2) 0.1-5 wt %, preferably 0.5-3 wt %, more preferably 1-2 wt %, of at least one propylene polymer having Polydispersity Index value (P.I.(2)) greater than or equal to 15 and fulfilling the equation P.I.(2)−P.I.(1)≧10.

In process step (a) the polypropylene resin (1) and the at least one propylene polymer (2) are melt blended under high shear conditions. The polypropylene resin (1) and the at least one propylene polymer (2), in form of lenticular pellets, can be metered simultaneously or separately directly to a single- or twin-screw extruder, into the same or different sections of the equipment. According to this embodiment, before step (a) is carried out, the at least one propylene polymer (2) is pelletized in a conventional pelletizer unit and optionally blended with customary additives. Alternatively, and more preferably, before step (a) is carried out, the at least one propylene polymer (2) in powder form is pre-mixed at ambient temperature with customary additives and optionally with part of the total amount of the polypropylene resin (1) in a conventional mixer (ex. a tumble-mixer) to obtain a dry blend to be fed to the extruder. The extruder's temperature depends on the melting temperatures of the polypropylene resin (1) and of the at least one propylene polymer (2) and it normally ranges from 190 to 230° C., preferably from 200 to 220° C., with a final melt temperature (die temperature) ranging from 210° to 260° C., preferably from 220° to 240° C.

In step (b), the molten resin is normally cooled down to a temperature comprised in the range from 20° to 40° C. with water at ambient temperature, i.e. about 25° C.

According to a further preferred embodiment, the step (a) of the process of the present invention comprises mixing in the molten state a polyolefin composition comprising (percentages based on the sum of components (1), (2) and (3)):

(1) 95-99.9 wt % of a polypropylene resin having a Polydispersity Index value P.I.(1);

(2) 0.095-4.5 wt % of at least one propylene polymer having Polydispersity Index value (P.I.(2)) greater than or equal to 15; and

(3) 0.005-0.5 wt %, preferably 0.01-0.3 wt %, of at least one further nucleating agent, wherein the P.I.(1) and P.I.(2) values fulfill the equation P.I.(2)−P.I.(1)≧10.

According to this further preferred embodiment, the step (a) can be carried out by metering the components (1), (2) and (3) of the polyolefin composition into a conventional extruder operating under the conditions described above. Alternatively, and more preferably, before step (a) is carried out, the at least one propylene polymer (2) in powder form can be pre-mixed at ambient temperature in a conventional mixer (ex. a tumble-mixer) with the at least one further nucleating agent (3) and optionally with part of the total amount of the polypropylene resin (1); the thus obtained dry blend is subsequently fed to the extruder.

Nucleating agents commonly used in the art are suitable as component (3) in present invention, for example inorganic additives such as talc, silica or kaolin, salts of monocarboxylic or polycarboxylic acids, e.g. sodium benzoate or aluminum tert-butylbenzoate, dibenzylidenesorbitol or its C₁-C₈-alkyl-substituted derivatives such as methyldibenzylidenesorbitol, ethyldibenzylidenesorbitol or dimethyldibenzylidenesorbitol or salts of diesters of phosphoric acid, e.g. sodium 2,2′-methylenebis(4,6,-di-tert-butylphenyl)phosphate. Particularly preferred are 3,4-dimethyldibenzylidenesorbitol; aluminum-hydroxy-bis[2,2′-methylene-bis(4,6-di-t-butylphenyl)phosphate]; sodium 2,2′-methylene-bis(4,6-ditertbutylphenyl)phosphate and bicyclo[2.2.1]heptane-2,3-dicarboxylic acid, disodium salt (1R,2R,3R,4S).

The process for nucleating polypropylene resins according to the instant invention brings about a sensible cost reduction in the production of nucleated polypropylene resins if compared to processes wherein conventional nucleating agents are used in customary amounts.

The polypropylene resins obtainable from the process of the invention preferably have a crystallization temperature Tc(1)^{I} which is at least 5° C., preferably at least 10° C., higher than the crystallization temperature Tc(1) of the polypropylene resin (1).

The polypropylene resins obtainable from the process of the invention have improved optical and physical/mechanical properties and can be conveniently used for the manufacture of molded and extruded articles, in particular for the manufacture of thin-walled articles such as articles obtained by thermoforming, extrusion or extrusion blow molding. It has been found that the polypropylene resins obtained from the process of the invention are particularly suitable for producing extrusion blow-molded article, such as bottles, having superior mechanical and optical properties if compared to articles obtained from polypropylene resins nucleated with conventional nucleating agents.

The following examples are given to illustrate and not to limit the present invention.

### EXAMPLES

The data were obtained according to the following methods:

Polydispersity Index (Pi.): Determined at a temperature of 200° C. by using a parallel plates rheometer model RMS-800 marketed by RHEOMETRICS (USA), operating at an oscillation frequency which increases from 0.1 rad/sec to 100 rad/sec. From the crossover modulus one can derive the P.I. by way of the equation:

P.I.=10⁵/Gc

in which Gc is the crossover modulus defined as the value (expressed in Pa) at which G′=G″ wherein G′ is the storage modulus and G″ is the loss modulus.

Xylene-soluble faction: 2.5 g of polymer and 250 mL of o-xylene are introduced in a glass flask equipped with a refrigerator and a magnetical stirrer. The temperature is raised in 30 minutes up to the boiling point of the solvent. The so obtained solution is then kept under reflux and stirring for further 30 minutes. The closed flask is then kept for 30 minutes in a bath of ice and water and in thermostatic water bath at 25° C. for 30 minutes as well. The solid thus obtained is filtered on quick filtering paper and 100 ml of the filtered liquid is poured in a previously weighed aluminum container, which is heated on a heating plate under nitrogen flow, to remove the solvent by evaporation. The container is then kept on an oven at 80° C. under vacuum until constant weight is obtained. The residue is weighed to determine the percentage of xylene-soluble polymer.

Comonomer content: By IR spectroscopy.

Melt Strength: The apparatus used is a Toyo-Sieki Seisakusho Ltd. melt tension tester provided with a computer for data processing. The method consists in measuring the tensile strength of a strand of molten polymer stretched at a specific stretch velocity. In particular, the polymer to be tested is extruded at 230° C. at 0.2 mm/min through a die with a capillary hole 8 mm long and 1 mm in diameter. The exiting strand is then stretched, by using a system of traction pulleys, at a constant acceleration of 0.0006 m/sec², measuring the tension until the breaking point. The apparatus registers the tension values of the strand as a function of the stretching. The melt strength corresponds to the melt tension at polymer break.

Melt flow rate (MFR): Determined according to ISO 1133 (230° C., 2.16 Kg)

Flexural modulus: Determined according to ISO 178

IZOD Impact Strength: Determined according to ISO 180/1A

Stress and Elongation at yield and at break: Determined according to ISO 527

Number of gels (fisheye count): The determination of the number of gels per m² is carried out by visually detecting the number of gels of a sample film projected by a projector on a white wall-chart with a magnificated scale. Film pieces of 130×7.5 cm are cut from a cast film at least 30 minutes after extrusion (die temperature in the range from 250° to 290° C., chill rolls temperature 20° C.). The film thickness is of 0.1 mm propylene homopolymers and of 0.05 mm for propylene copolymers. The counting is made on 5 different pieces of the same film and a final number is given by the expression No=A/S where No is the number of gels per m², A is the number of gels counted on 5 film pieces and S is the overall surface in m² of the 5 films pieces examined. Gels of irregular shape are measured at the point of maximum extension.

Molar ratio of feed gasses: Determined by gas-chromatography

Melting temperature, melting enthalpy (ΔHm), crystallization temperature and crystallization enthalpy (ΔHc): Determined by DSC with a temperature variation of 20° C. per minute.

Isothermal half crystallization time (t1/2): the test specimens are heated at 40° C./min to 220° C. and annealed at this temperature for 3 min. The samples are quenched to 130° C. with a cooling rate of 20° C./min and hold at this temperature until full crystallization. The half crystallization time is defined as the time necessary to crystallize the 50 wt % of the resin in an isothermal crystallization.

Haze: Specimens of 5×5 cm size were cut from the extruded and extrusion blow molded items of the Examples 1-3 and Comparative Examples 1-5. The test specimens were placed in the instrument supporting frame in front of the light beam of a Hazegard Plus instrument (by BYK-Gardner) and the measurement was subsequently carried out. Testing was carried out at 23° C., with each test specimen being examined once in the middle.

Clarity and Gloss: measured with Microgloss 60/45 (by BYK-Gardner) glossmeter on 5×5 cm specimens cut from the extruded and extrusion blow molded items of the Examples 1-3 and Comparative Examples 1-5.

Top Load: For the test a Instron dynamometer was used, equipped with a balance of 0.2 gr accuracy and with a micrometer of 0.01 mm accuracy. After at least 10-hours conditioning at 23°±1° C. and 50% relative humidity, the bottle is settled between the two plates of the dynamometer and compressed with a stress velocity of the plate of 5 cm/min. The stress at collapse of the bottle is recorded and the value reported in N. The Top Load value is the mean value obtained from measurements repeated on 10 bottles.

Preparation of the propylene polymer (2)

The solid catalyst used in the preparation of the propylene polymer (2) was prepared according to the Example 10 of the International Patent Application WO 00/63261. Triethylaluminium (TEAL) was used as co-catalyst and dicyclopentyldimethoxysilane as external donor, with the weight ratios indicated in Table 1. The propylene polymer (2) was prepared in one single polymerization step by feeing the monomers and the catalyst system to a gas-phase polymerization reactor comprising two interconnected polymerization zones, a riser and a downcomer, as described in the International patent application WO00/02929. The comonomer was fed exclusively into the first polymerization zone (raiser); means were provided which are capable of totally or partially preventing the gas and/or liquid mixture present in the raiser from entering the downcomer. The molecular weight regulator, i.e. hydrogen, was fed only to the riser. The polymerization conditions are indicated in Table 1. The obtained polymer particles were subjected to a steam treatment to remove the unreacted monomers and dried. Mechanical properties of the as-reactor propylene polymer (2) are collected in Table 1.

### Example 1 and Comparative Example 1

As polypropylene resin (1) a propylene/ethylene copolymer having the properties indicated in Table 2 was used. The polypropylene resin (1) was melt blended in a Werner ZSK 58 extruder to obtain a final composition containing 500 ppm of calcium stearate, 1500 ppm of Irganox B215 (by Ciba Specialty Chemicals) and 4000 ppm the propylene polymer (2) and subsequently cooled with water. The extruder was operated under nitrogen atmosphere at 220 rpm and at a temperature of 200° C.; the melt temperature was 216° C. Prior to melt blending, the as-reactor propylene polymer (2) in powder form was pre-mixed at ambient temperature with calcium stearate, Irganox B215 and a small amount of polypropylene resin (1) and the thus obtained dry blend was fed to the extruder. Thermal properties of the polypropylene resin nucleated with the process of the invention are compared in Table 3 with the thermal properties of the polypropylene resin (1) to which no nucleating agent was added (Comparative Example 1).

TABLE 1

| | | |
|---|---|---|
| TEAL/Donor | g/g | 2.5 |
| TEAL/Catalyst | g/g | 5 |
| Temperature | ° C. | 80 |
| Pressure | MPa | 2.8 |
| H2/C3 | mol/mol | 0.00765 |
| P.I. (2) | | 30.0 |
| MFR (2) | g/10′ | 1.0 |
| C2 (2) | wt % | 1.8 |
| X.S. | wt % | 3.4 |
| Flexural modulus | MPa | 1724 |
| Stress at yield | MPa | 38.4 |
| Elongation at yield | % | 7.7 |
| Stress at break | MPa | 24.4 |
| Elongation at break | % | 37 |
| IZOD 23° C. | kJ/m2 | 4.9 |
| Melting temperature | ° C. | 156 |
| Melting enthalpy | J/g | 89 |
| Tc(2) | ° C. | 105 |
| No (≧0.2 mm) | n°/m2 | 0 |
| No (≧0.1 mm) | n°/m2 | 0 |
| Melt Strength ⁽*⁾ | cN | 3.53 |

⁽*⁾ The Melt Strength value was measured on pelletized propylene polymer (2).

TABLE 2
Polypropylene resin (1)

| | | |
|---|---|---|
| C2 (1) | wt % | 4.3 |
| MFR (1) | g/10 min | 1.5 |
| P.I. (1) | | 3.5 |
| P.I. (2) − P.I. (1) | | 26.5 |

TABLE 3

| | | Ex. 1 | Comp. Ex. 1 |
|---|---|---|---|
| Tm | ° C. | 137.3 | 134.9 |
| ΔHm | J/g | 65 | 62.5 |
| Tc | ° C. | 97 | 88.9 |
| ΔHc | J/g | −68.3 | −69.8 |

The effectiveness of the propylene polymer (2) as nucleating agent is evidenced by the increase in the crystallization temperature of the polypropylene resin (1).

### Example 2

The polypropylene resin (1) used in Example 1 was melt blended in a conventional Werner ZSK 53 extruder with the amounts of nucleating agents indicated in Table 4; the extruded strands were subsequently cooled in a water bath kept at ambient temperature and cut. The extruder was operated under nitrogen pressure at 240 rpm and at a temperature of 200° C.; the melt temperature was 238° C. The propylene polymer (2) in powder form was pre-mixed at ambient temperature with the further nucleating agents Millad 3988 and ADK-NA21 (component (3)), with the same amount of Irganox B215 and calcium stearate as in Example 1 and a small amount of polypropylene resin (1). The thus obtained dry blend was fed to the extruder.

Millad 3988 (supplied by Milliken Chemical) contains 3,4-dimethyldibenzylidenesorbitol; ADK-NA21 (supplied by Adeka Palmarole) contains aluminum hydroxy-bis[2,2′-methylenebis(4,6-di-t-butylphenyl)phosphate].

The polypropylene resin of Example 2 was shaped into bottles by extrusion blow molding on an Automa Speed 3M line (screw diameter: 70 mm, length: 24L/D). The line was operated to obtain a temperature of the molten resin of 184° C. The parison of molten resin was fed to an aluminum mold kept at a temperature of 25° C. and subsequently blown with air pressure.

The bottles had cylindrical form (bottom diameter: 88 mm, high: 240 mm, wall-thickness: 450±50 micron), 1 liter capacity and weighted 35.0±0.5 g. The mechanical and optical properties of the bottles are collected on Table 4.

### Comparative Example 2

The polypropylene resin (1) used in Example 2 was added with the same amount of Irganox B215 and calcium stearate as in Example 1, extruded and shaped into bottles under the same conditions used in Example 2. Properties are collected on Table 4.

### Comparative Examples 3 and 4

The polypropylene resin (1) used in Example 2 was melt blended in a conventional Werner ZSK 53 extruder (operating under the same conditions as in Example 2) with the amounts of nucleating agents indicated in Table 4 and with the same amount of Irganox B215 and calcium stearate as in Example 1. The polypropylene resins thus obtained were shaped into bottles under the same conditions used in Example 2. Properties are collected in Table 4.

TABLE 4

| | | | | Comp. | Comp. |
|---|---|---|---|---|---|
| | | Ex. 2 | Comp. Ex. 2 | Ex. 3 | Ex. 4 |
| Propylene polymer (2) | wt % | 1.0 | / | / | / |
| Millad 3988 | wt % | 0.01 | / | 0.18 | 0.01 |
| ADK-NA21 | wt % | 0.05 | / | / | 0.05 |
| Tm | ° C. | 141.3 | 135.5 | 141.7 | 141.0 |
| Tc | ° C. | 105.3 | 89.5 | 105.5 | 104.0 |

Properties on bottles

| | | | | | |
|---|---|---|---|---|---|
| Haze | % | 17.5 | 43 | 18 | 20.5 |
| Clarity | % | 79.6 | 60.5 | 66.1 | 55.6 |
| Top Load | N | 210 | / | 180 | 150 |

The polypropylene resin obtainable from the process of the invention has improved optical properties if compared to the un-nucleated polypropylene resin (Comparative Example 2). Moreover, the polypropylene resin nucleated with the process according to the present invention shows superior clarity and transparency in connection with improved mechanical properties if compared to the same polypropylene resin nucleated with conventional nucleating agents.

### Example 3

As polypropylene resin (1), a propylene/ethylene copolymer having the properties collected on Table 5 was used.

TABLE 5
Polypropylene resin (1)

| | | |
|---|---|---|
| C2 (1) | wt % | 2.0 |
| MFR (1) | g/10 min | 5.7 |
| P.I. (1) | | 4.5 |
| P.I. (2) − P.I. (1) | | 25.5 |
| Tc | ° C. | 105 |
| Xylene soluble fraction | wt % | 2.7 |

The propylene/ethylene copolymer was melt blended with the amounts of nucleating agents indicated in Table 6 in a conventional Werner 58 extruder and the molten resin was subsequently cooled and pelletized under water-cutting system. The extruder was operated under nitrogen atmosphere at 190 rpm and at a temperature of 200° C.; the melt temperature was 216° C. Prior to melt blending, the as-reactor propylene polymer (2) in powder form was pre-mixed at ambient temperature with ADK-NA21 (component (3)), with the same amount of calcium stearate and Irganox B215 as in Example 1 and a small amount of polypropylene resin (1). The thus obtained dry blend was fed to the extruder. The optical properties of extruded sheets obtained from the polypropylene nucleated resin were measured and collected in Table 6.

### Comparative Example 5

The propylene/ethylene copolymer of example 3 was melt blended with the amounts of ADK-NA21 indicated in Table 6 in a conventional Werner 58 extruder operating under the same conditions as in Example 3. The optical properties of extruded sheets obtained from the polypropylene nucleated resin were measured and collected in Table 6.

TABLE 6

| | | Ex. 3 | Comp. Ex. 5 |
|---|---|---|---|
| Propylene polymer (2) | wt % | 2.0 | / |
| ADK-NA21 | wt % | 0.1 | 0.12 |
| Tm | ° C. | 152.9 | 152.0 |
| Tc | ° C. | 116 | 115.5 |
| T½ | min | 1.57 | 2.21 |

Extrusion conditions for sheets

| | | | |
|---|---|---|---|
| Die temperature | ° C. | 210 | 210 |
| Thickness | mm | 1.485 | 1.505 |

Optical properties

| | | | |
|---|---|---|---|
| Haze | % | 38.5 | 42.6 |
| Clarity | % | 92.8 | 87.6 |
| Gloss (60°) | % | 75.7 | 66.8 |

T1/2 is the half-crystallization time of the polypropylene resin.

1. (canceled)

2. A process for nucleating polypropylene resins comprising the steps:
(a) mixing in the molten state a polyolefin composition comprising:
(1) from 95 to 99.9 wt % of a polypropylene resin having a Polydispersity Index value P.I.(1); and
(2) from 0.1 to 5 wt % of at least one propylene polymer having a Polydispersity Index value (P.I.(2)) of at least 15,
wherein the P.I.(1) and P.I.(2) values fulfill the equation P.I.(2)−P.I.(1)≧10, thereby forming a molten blend; and
(b) cooling the molten blend.

3. The process according to claim 1, wherein the
polypropylene resin (1) further comprises a crystallization temperature Tc(1) and comonomer content C(1), and
the at least one propylene polymer (2) further comprises a crystallization temperature Tc(2) and comonomer content C(2) fulfilling at least one of the following conditions:
(i) Tc(2)≧Tc(1);
(ii) C(2)≠C(1).

4. The process according to claim 2, wherein the at least one propylene polymer (2) is selected from propylene homopolymers, propylene copolymers containing up to 10.0 wt %, with respect to the weight of the copolymer, of alpha-olefin units having from 2 to 8 carbon atoms other than propylene or mixtures thereof.

5. The process according to claim 2, wherein the polyolefin composition comprises:
(1) 95-99.9 wt % of the polypropylene resin having the Polydispersity Index value P.I.(1);
(2) 0.095-4.5 wt % of the at least one propylene polymer having the Polydispersity Index value (P.I.(2)) of at least 15; and
(3) 0.005-0.5 wt % of at least one further nucleating agent.

6. A nucleated polypropylene resin obtained from a process comprising:
(a) mixing in the molten state a polyolefin composition comprising:
(1) from 95 to 99.9 wt % of a polypropylene resin having a Polydispersity Index value P.I.(1) and a crystallization temperature Tc(1); and
(2) from 0.1 to 5 wt % of at least one propylene polymer having a Polydispersity Index value (P.I.(2)) of at least 15,
wherein the P.I.(1) and P.I.(2) values fulfill the equation P.I.(2)−P.I.(1)≧10, thereby forming a molten blend; and
(b) cooling the molten blend, wherein the nucleated polypropylene resin comprises a crystallization temperature Tc(1)^{I} which is at least 5° C. higher than the crystallization temperature Tc(1) of the polypropylene resin (1).

7. Articles comprising a nucleated polypropylene resin obtained from a process comprising:
(a) mixing in the molten state a polyolefin composition comprising:
(1) from 95 to 99.9 wt % of a polypropylene resin having a Polydispersity Index value P.I.(1) and a crystallization temperature Tc(1); and
(2) from 0.1 to 5 wt % of at least one propylene polymer having a Polydispersity Index value (P.I.(2)) of at least 15,
wherein the P.I.(1) and P.I.(2) values fulfill the equation P.I.(2)−P.I.(1)≧10, thereby forming a molten blend; and
(b) cooling the molten blend, wherein the nucleated polypropylene resin comprises a crystallization temperature Tc(1)^{I} which is at least 5° C. higher than the crystallization temperature Tc(1) of the polypropylene resin (1).

8. A polyolefin composition comprising:
(1) 95-99.9 wt % of a polypropylene resin having a Polydispersity Index value P.I.(1), said resin being selected from
(i) propylene homopolymers having a solubility in xylene lower than 10 wt %,
(ii) propylene copolymers containing from 0.05 to 20 wt %, with respect to the weight of the copolymer, of alpha-olefin units having from 2 to 10 carbon atoms other than propylene, said propylene copolymers having solubility in xylene lower than 15 wt %,
(iii) mixtures of propylene homopolymers of item (i) and propylene copolymers of item (ii), and
(iv) heterophasic compositions comprising (1) a propylene polymer selected among propylene polymers of item (i), (ii) and (iii), and (2) up to about 40 wt %, with respect to the weight of the heterophasic composition, of an elastomeric propylene copolymer containing up to about 50 wt %, with respect to the elastomeric fraction, of at least one comonomer unit selected from alpha-olefins having from 2 to 10 carbon atoms other than propylene; and
(2) 0.1-5 wt % of a propylene polymer having a Polydispersity Index value P.I.(2) of at least 15, said propylene polymer being selected from propylene homopolymers, propylene copolymers containing up to 5.0 wt %, with respect to the weight of the copolymer, of alpha-olefin units having from 2 to 8 carbon atoms other than propylene or mixtures thereof,
wherein the P.I.(1) and P.I.(2) values fulfill the equation P.I.(2)−P.I.(1)≧10.
